(19) United States
(12) Patent Application Publication
(10) Pub. No.: US 2009/0126628 A1
(43) Pub. Date: May 21, 2009

(54) RADIATION APPLIANCE, POWDER APPLYING STATION, ARRANGEMENT FOR COATING TEMPERATURE-SENSITIVE MATERIALS, AND ASSOCIATED METHOD

(76) Inventor: Gerhard Brendel, Auerbach (DE)

Correspondence Address: PRICE HENEVELD COOPER DEWITT & LITTON, LLP, 695 KENMOOR, S.E., P O BOX 2567, GRAND RAPIDS, MI, 49501, US

(21) Appl. No.: 11/721,125

(22) PCT Filed: Jun. 15, 2005
(86) PCT No.: PCT/EP05/56543

§ 371 Date: Dec. 11, 2008

(30) Foreign Application Priority Data
Dec. 10, 2004 (DE) 10 2004 059 634.4
Jan. 26, 2005 (DE) 10 2005 003 802.6

(51) Int. Cl. G01J 3/10; B05B 5/025

(52) U.S. Cl. 118/708; 250/504 R; 118/641; 118/621

(57) ABSTRACT

The invention relates to a radiation appliance (21) and a powder-application station (4), an arrangement thereof for powder-coating temperature-sensitive materials, such as timber-derived products and MDF panels (8), and an associated method. The inventive arrangement and method are characterised in that the specific geometry of the radiation appliance (21) or the corresponding mode of operation enables a short but sufficient homogeneous radiation action over the surface of the substrate (8) to be coated, without the core temperature of the substrate exceeding a critical value. Said arrangement comprises a grinding station (1), a flame-treatment station (2), a spray station (3), a powder-application station (4), a radiation appliance (5), and a curing/crosslinking region (6) that can preferably be continuously passed through. The inventive radiation appliance (21) is characterised in that the radiating elements are displaceably arranged in an annular or circular manner, while the powder-application station (4) is provided with diverting elements which are used to smooth the electrical field on the surface of the substrates and thus prevent concentrations of powder on edges and the like.

### TECHNICAL FIELD

The present invention concerns a radiation appliance, an arrangement for powder-coating, a powder-application station as well as a powder-coating method.

### PRIOR ART

The furniture industry has for some time been attempting to powder-coat or to apply powder paint to timber-derived materials and especially wood fiber materials such as MDF elements (medium density fiber), instead of painting them. Compared with the wet-coating method, powder coating or the powder paint has the advantage that various working steps such as application of primers, filling layers, etc. and pertinent intermediate steps such as grinding and the like can be dispensed with and, additionally, an extremely attractive and smooth surface can be created that can be provided with many effects.

However, powder coating requires high temperatures for melting and curing or crosslinking the powder. Usually, temperatures of over 120° C. to 200° C. must be achieved. These temperatures are too high, however, for heat-sensitive substrates, such as timber-derived materials or wood fiber materials (MDF panels), since they can lead to evaporation of the moisture in the wood and so cause cracking.

For this reason, there have already been attempts to use radiation sources and corresponding oven treatments to melt and cure or crosslink powders applied to MDF panels or wood materials.

However, here it has transpired that either the temperature load of the heat-sensitive substrate remained too great or, in problem areas, such as at the edges, it was not possible to achieve a sufficiently homogeneous coating.

### DISCLOSURE OF THE INVENTION

### Technical object

It is therefore the object of the present invention to provide devices or a method for facilitating overall homogeneous powder coating of heat-sensitive substrates, such as MDF panels or other timber-derived materials, with a particular goal being to render the workflow simple and efficient and to make the devices easy to manufacture.

### Technical Solution

This object is achieved with a radiation appliance having the characteristics of claims 1 or 3, an arrangement having the characteristics of claim 12, a powder-application station having the characteristics of claim 22 as well as a method having the characteristics of claim 24. Advantageous embodiments are the subject of the dependent claims.

The invention proceeds from the realization that when heat-sensitive substrates, such as timber-derived materials or especially MDF panels, are being powder-coated, the surface, more precisely all areas, must be heated rapidly, without the core temperature of the substrate exceeding critical values. In addition, sufficient time must be allowed for the powder to cure or crosslink. In order that these requirements may be satisfied, a radiation appliance with energy-radiating elements, especially heat-radiating elements, preferably short-wave infrared (IR) radiating elements or ultraviolet (UV) radiating elements, is provided after a first aspect of the invention, with the energy-radiating elements being arranged on a carrier and being movable with the carrier or collectively, and/or are arranged in a circular or annular manner. The effect of these measures is that the object which is to be transported past the radiation appliance and to which the powder adheres can be exposed to uniform radiant power, without the occurrence of overheating.

One particular way in which this is achieved in the movable embodiment of the radiating elements or of the carrier consists of implementing the movement such that the carrier base structure with the radiating elements or the radiating elements themselves are moved back and forth, more precisely either linearly or in a rotational or swiveling manner parallel to the direction in which the object is transported, such that the exposure of any point to the radiation is temporally very limited, but such that the whole area of the object/substrate to be coated is exposed.

Alternatively or in combination with this, the radiating elements may be arranged in a circular or annular manner, since this, too, ensures that substrates of various shapes, especially panel-shaped substrates, which are moved past the radiating elements undergo uniform, especially repeated, but not excessively long exposure to the radiation.

Preferably, the radiating elements are arranged such that they project above the substrate in one direction at least in order that the radiation may reach all surfaces of the substrate.

For this purpose, the radiating elements, preferably on the carrier as well, are adjustably arranged such that their principal radiant direction may be aligned with the object to be irradiated. This has been achieved with assembly elements which are swivelably arranged on a carrier base structure, for example in annular, panel or disc form, and more precisely about an axis in the plane of the carrier base structure, such that the radiating elements mounted to the assembly elements may be swiveled out from the carrier base structure plane and the principal radiant direction of the radiating elements varies from the normal of the carrier base structure plane.

In all other respects, however, it is clear that, in addition to the capability of the emitters to swivel out of the plane of the carrier base structure for the purpose of adaptation to the substrate geometry for coating, the inventive mobility of the carrier or the emitters occurs parallel to the transport direction of the substrates to be coated or objects parallel to or in the plane in which essentially the emitter(s) are arranged.

The short-wave or medium-wave infrared radiating elements preferably finding use may be especially formed as linear radiating elements in a segmented arrangement or as annular or circular radiating elements. Accordingly, the radiation appliance may be provided with only one radiating element in the case of unilateral irradiation, or two or more radiating elements in the case of unilateral and bilateral irradiation. Simultaneous bilateral irradiation is preferred in which one carrier base structure with the radiating element or radiating elements on it is arranged opposite another such that between them they cover the transportation path for the object to be coated.

Preferably, the distance between the two opposing carrier base structures with the radiating elements arranged on them may also be varied in order that the radiant power impinging on the surface may be adjusted by changing the distance.

In addition to the aforementioned infrared radiating elements, all other possible energy radiating elements, especially also UV radiating elements, may be arranged on the radiation appliance.

An inventive arrangement for the powder coating of heat-sensitive materials with the radiation appliance described above comprises, after a further aspect, an upstream powder-application station and a downstream region for curing or crosslinking the powder, preferably an oven and especially a forced-air circulation oven. Especially, it is also possible to use the inventive radiation appliance in the downstream curing and crosslinking region, especially in the case of UV-curable paint systems. In that case, the corresponding arrangement comprises, for example, one or more radiation appliances with IR radiating elements between the powder-application station and the curing or crosslinking region and one or more radiation appliances with UV-radiating elements in or downstream of the curing or crosslinking region. A combination of different energy radiating elements is also possible.

In accordance with the invention, the powder-application station in which the coating powder is preferably deposited on the substrate by means of electrostatic spraying has so-called diverting elements whose purpose is to deflect the charge and to smooth the field line pattern on the object to be coated, such that the coating powder does not accumulate at those edges of the object where field concentrations usually occur.

Preferably, the diverting elements are arranged such that the object is arranged between them and an opposing spraying device during powder coating, i.e., the diverting element is located behind the object to be coated from the viewpoint of the spraying device or powder-coating device.

The diverting elements are preferably formed as perforated metal sheets, vertical blinds, shields or lattice structures.

Since powder accumulates on the diverting elements, a mechanism is preferably provided, with which the diverting elements may be cleaned in a simple manner, for example by shaking off the powder.

The powder-application station suspension or storage of the substrates for coating is effected by means of retaining elements, especially hooks, which, on one hand, are formed so as to be electrically conductive for diverting charge, but, on the other, are isolated in areas in which they are not in direct contact with the substrates, in order that field line concentrations and powder accumulations may be avoided.

In the inventive arrangement for powder-coating heat-sensitive substrates, the region provided for curing and crosslinking the powder advantageously follows immediately after the radiation appliance in order that no heat loss may occur between melting of the powder and subsequent heat treatment during curing and crosslinking. Preferably, the radiation appliance may also be integrated into the entrance area of the curing/crosslinking region.

In a preferred embodiment of the present invention, the curing/crosslinking region is formed by a forced-air circulation oven in which the air circulation may be implemented either from top to bottom, from bottom to top, both from bottom to top and from top to bottom with lateral circulation of air and/or with alternating air circulation from bottom to top.

Since the melting of the powder in the radiation appliance affords sufficient adhesive action of the melted powder on the substrate, the forced-air circulation oven may be operated at a high air speed in the region of 1 to 5 m/s, preferably approx. 2 to 4 m/s, such that a large area of constant temperature is set especially over the entire substrate to be coated.

Preferably, the oven is divided into several zones in which different temperatures may be set such that, on passing through the forced-air circulation oven, the substrate to be coated can pass through a temperature profile. This ensures that the temperature necessary for curing and crosslinking may be kept sufficiently high on the surface, while the core temperature remains beneath a critical value.

The number of zones is arbitrary, with values in the region of 3 to 5 zones having proved satisfactory.

For temperature control in the forced-air circulation oven or in other heating devices for curing and crosslinking of the powder, sensors, especially infrared sensors for measuring the surface temperature, may be provided that adjust the temperature on the basis of the measured values to the desired value via a control unit.

By way of alternative to the forced-air circulation oven or other devices for curing or crosslinking or combination thereof serving as a post-curing device, the inventive radiation appliance may also be used at this point of the arrangement, for example for post-curing UV-curable coating systems with UV radiating elements.

Before the powder is deposited on the substrate to be coated, for which purpose, in addition to the aforementioned electrostatic spraying, other known methods may be used, it is advantageous to pre-treat the material in an appropriate way. Accordingly, corresponding treatment stations are provided in an inventive installation for the powder coating of heat-sensitive materials, such as MDF panels.

First, a climate chamber may be provided in which the substrates to be coated are kept until treatment can be commenced. The reason for this is that the timber-derived materials and, especially, MDF panels have a certain moisture content which they should not exceed or, especially, undershoot, and which lies in the range of greater than or equal to 5, preferably greater than 8, especially 5 to 15 wt % moisture. A minimum moisture is necessary for ensuring adequate sufficient conductivity (resistance R=approx. 10Ω), although, by avoiding excessive moisture, the problem of cracking may be counteracted.

Furthermore, it is advantageous to grind the wood or MDF materials at the beginning in order that a smooth surface may be obtained.

Subsequently, a flame-treatment station may be provided in which the surface is flame-treated in order that projecting wood fibers may be removed and the surface area compacted by exposure to the flames.

For this purpose, a plasma-treatment device may be provided additionally or alternatively.

Furthermore, it has proved advantageous to treat the MDF panels or timber-derived materials with a primer, especially a biodegradable primer, that constitutes an air-tight or vapor-proof barrier layer for the moisture contained in the material and, above and beyond that, seals the pores in the surface of the workpiece.

Preferably, the primer is applied by water-vapor-assisted spraying, as described in German patent application DE 10 2004 012 889, whose full scope is included in this application.

Water-vapor-assisted spraying enables especially water-soluble primers with very good surface properties to be applied very smoothly, with an additional advantage consisting in the fact that the primer dries very quickly and may be further processed directly such that a continuous installation for coating heat-sensitive materials may be realized.

### BRIEF DESCRIPTION OF THE DRAWINGS

Further advantages, characteristics and features of the present invention are apparent from the following detailed description of an embodiment. The attached drawings show here in purely schematic form in

FIG. 1 is an inventive installation for the powder coating of MDF panels;

FIGS. 2a, 2b are a lateral view and a transverse view of an inventive radiation appliance, which is used in the arrangement in FIG. 1; and in

FIG. 3 is a temperature-time diagram for an MDF panel treated in the installation of FIG. 1, during irradiation by the radiation appliance and during passage through the forced-air circulation oven.

### BEST WAY TO IMPLEMENT THE INVENTION

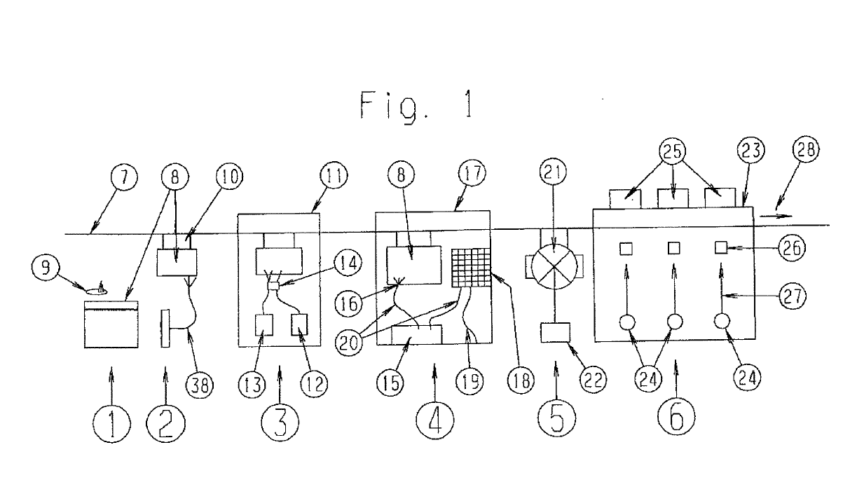

FIG. 1 shows in a schematic illustration the structure of an inventive installation for the powder coating of MDF panels 8, as used in the furniture industry.

In the embodiment shown, the installation has a total of six processing stations 1 to 6, through which the MDF panel 8 passes by means of a transport device 7. In the embodiment shown, the transport device 7 is realized by a rail arrangement that accommodates mounting panels 10 into which the MDF panel 8 can be suspended.

In the first processing station 1, the surfaces of the MDF panel 8 are processed by means of a grinder 9 such that a smooth, clean surface develops.

Subsequently, the surface of the MDF panel is flame-treated in processing station 2 by means of a gas burner 38, shown schematically, in order that any wood fibers remaining after the grinding process may be removed and the surface compacted by exposure to the flames.

Alternatively or additionally, after or instead of processing station 2 with flame-treatment, a plasma treatment installation (not shown) may be provided, with compaction of the surface also occurring due to exposure to the plasma.

A spraying installation with a spray booth 11 and a spraying device 14 are shown in the processing station 3, by means of which a primer is applied to the surface of the MDF panel 8 by means of water-vapor-assisted coating. The primer serves to seal the surface gas-tight and to fill the pores in the surface of the MDF panel 8, as is described in the patent application by Patrick Oliver Ott concerning a method for pre-treating surfaces of wood and/or wood fiber composite blanks for subsequent powder or film coating.

Preferably, a water-soluble primer, which may be a commercial primer, is used, since, when this is used in conjunction with a water-vapor-assisted method, as described in patent application DE 10 2004 012 889, it leads to particularly smooth and impervious surface layers. For this purpose, the spraying installation of processing station 3 contains a water-vapor-generation device in addition to the paint-supply device 13.

Furthermore, the water-vapor-assisted coating offers the advantage that the MDF panel 8 treated with primer may be transferred immediately after coating to the next processing station in a continuous process, since the high temperature of the water vapor is conducive to a very rapid drying process. If required, a buffer station, not shown here, may be incorporated into the arrangement in order that a certain drying time may be realized for the MDF panels 8.

Powder application occurs in the processing station 4, with the powder-application station 4 likewise having a housing 17 as well as corresponding devices for electrostatic powder application, such as spray guns 16, powder storage vessel 15, supply lines 20 and the like.

In accordance with the invention, a diverting element 18 is additionally provided opposite each powder-application means 16 in the powder-application station 4, said diverting element being earthed via the line 19 and serving to deflect surplus charge and to smooth the pattern of the field lines on the panel 8 to be coated in order that excessive powder coating may be avoided at the edges where field concentrations may occur.

In the embodiment shown in FIG. 1, the powder-application station 4 contains a powder-application means 16 in the form of a spray gun 16 for each side of the MDF panel 8, with diverting elements 18 arranged opposite the spray guns 16. In the embodiment shown in FIG. 1, however, only one diverting element 18 is to be seen while the other one is hidden by the MDF panel 8. Nor is the second powder-application spray gun 16 represented, since it is hidden by the diverting element 18. Only supply line 20 can be seen.

As may be further seen in FIG. 1, the diverting element 18 in the embodiment shown is formed as a lattice-like structure, in which the lattice bars are formed as flat bars having a depth of several centimetres (4 to 6 cm) and a thickness of approx. 0.5 to 1 cm. Apart from this embodiment of the diverting element 18, further embodiments are conceivable, such as vertical blinds, perforated metal sheets, slotted metal sheets and the like. Since a certain amount of powder will deposit on the diverting elements 18 over time, it is advantageous if a device is provided that permits occasional cleaning of the diverting elements 18, for example by corresponding shaking and the like.

The transport equipment 7 transfers the MDF panel 8 with the applied powder into the processing station 5 in which an inventive radiation appliance 21 with short-wave infrared radiating elements is provided, in order that powder present on the surface of the MDF panel 8 may be melted by very rapid, brief heating.

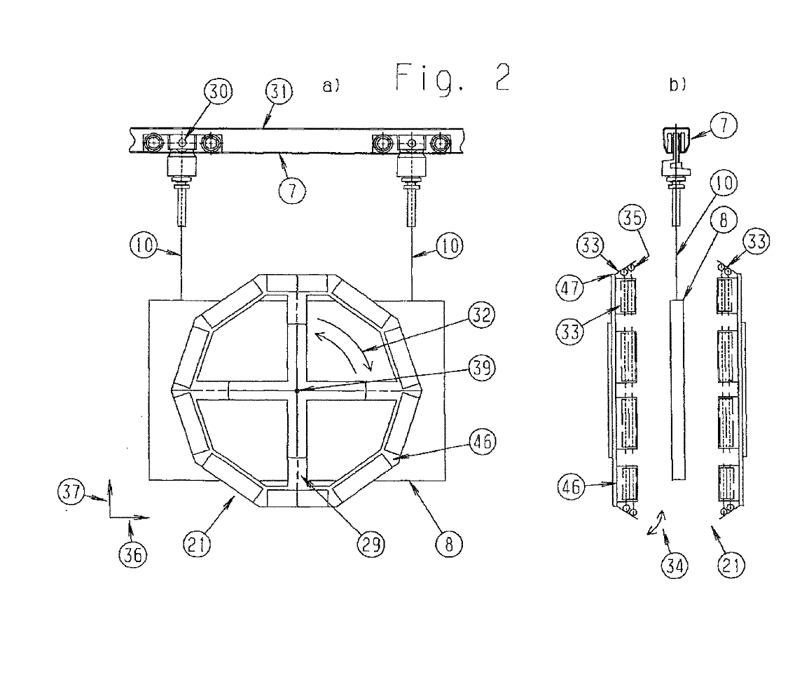

The radiation appliance 21 is illustrated in magnified form in FIG. 2a and FIG. 2b, with only a part of the radiation appliance, without the drive 22 (see FIG. 1), being shown.

As FIG. 2a and FIG. 2b show, the radiation appliance 21 has a spider 29 for carrying the infrared lamps 35. The spider 29 may, as indicated by the arrows 32, be rotated or swiveled about the axis 39, which is in the center of the spider 29.

A ring 46 in the shape of a polygon is provided on the spider 29. In the embodiment shown, the polygon ring 46 has ten linear sections, at which the infrared lamps 35 are arranged.

As may especially be seen in FIG. 2b, mounting panels 33 are provided at the polygon ring 46 or the individual linear sections, said mounting panels arranged about an axis of rotation 47 and inclined to the polygon ring 46 or to the spider 29, more precisely out of that plane which is spanned by the spider 29 or the polygon ring 46.

To this extent, the mounting panels 33 form an acute angle to the normal of the plane of the spider 29 or the polygon ring 46, which is perpendicular to the transport plane that is given by the MDF panel 8 or spanned by the transport direction 36 and the perpendicular 37 to it.

As indicated by the double arrow 34, the mounting panels 33 are swivelably arranged about the axis of rotation 47 such that the angle of inclination and the irradiation direction of the infrared lamps arranged at the mounting metals 33 are adjustable.

As is also clear from FIG. 2b, the polygon ring 46 with the infrared lamps 35 arranged thereon projects in the vertical direction above the MDF panels to be treated, such that the inclined arrangement of the infrared lamps at the mounting panels 33 creates the possibility for the infrared lamps to irradiate the upper side and the lower side of the suspended MDF panels 8.

Furthermore, since the capability of the carrier 29, 46, 47 to rotate or swivel creates the possibility, through back-and-forth swiveling of the spider 29 about the axis 39, of ensuring uniform irradiation peripherally around the carrier for the panel 8 passing through the radiation appliance 21, homogeneous powder coating is obtained in all areas of the MDF panel 8, especially also at the upper, lower and edge faces of the MDF panel 8. The polygon arrangement or circular or annular arrangement of the radiating elements effects a simple possibility of uniformly irradiating differently shaped objects and especially panels.

FIG. 2a and FIG. 2b further show the transportation device in greater detail, with the mounting panels 10 being arranged on movable carriages 30, which move in a rail arrangement 31 made from a largely closed hollow profile. The mounting panels are conductive in the contact area with the MDF panels and isolating elsewhere in order that diversion of charge may be ensured and field line concentrations otherwise avoided.

After passing through the radiation appliance with the short-wave infrared radiating elements, the MDF panel 8, thus processed, moves directly into a forced-air circulation oven 6 as the sixth processing station (see FIG. 1), in which in several zones, for example three zones, appropriately heated air is guided through inlet openings 24, for example, to the suction devices 25 from bottom to top (see arrow 27).

Since the powder adheres firmly to the surface of the MDF panel 8 due to the upstream treatment in the radiation appliance 21, it is possible to choose a very high setting for the speed of the circulation air, for example, in the region of 1 to 5 m/s, preferably 2 m/s, such that a constant temperature profile may be set over a large distance.

For the purpose of regulating the temperature, infrared sensors 26 may be used in the housing 23 of the forced-air circulation oven 6, said sensors capable of measuring the surface temperature of the MDF panel 8 and thus controlling the temperature regulation of the forced-air circulation oven 6.

Through the provision of different temperature zones in the forced-air circulation oven 6 along the transport direction 28, it is possible to keep the surface temperature at a constant high value for the purpose of rapid crosslinking and curing of the powder, while simultaneously keeping the core temperature of the MDF panel 8 below a critical temperature.

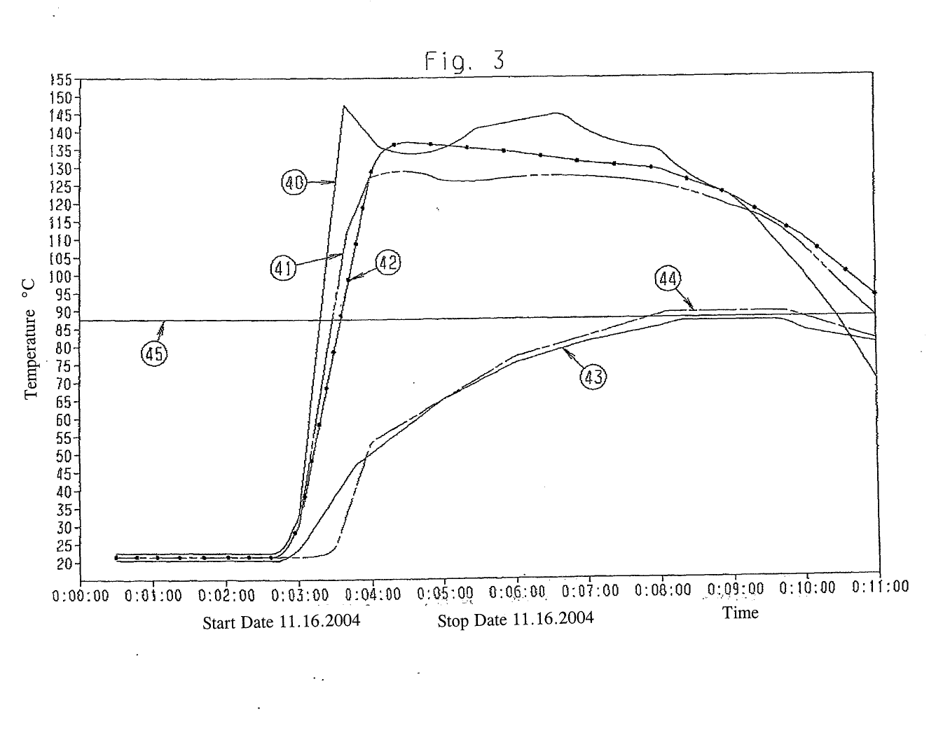

This is shown in the diagram of FIG. 3, in which the temperature is plotted against time. The horizontal line 45 indicates, for example, the desirable maximum core temperature for the MDF panel 8. The other curves indicate the ambient temperature in the proximity of the MDF panel (curve 40), the surface temperatures on the MDF panel (curves 41 and 42) as well as the core temperatures in the MDF panel (curves 43 and 44) during passage through the radiation appliance 21 and the forced-air circulation oven 6.

As may be inferred from the diagram, the radiation appliance 21 and heating with the short-wave infrared radiating elements 35 leads to very rapid heating of the surface and the powder adhering to it while the core temperature of the MDF panel 8 rises a great deal more slowly. Even after brief irradiation in the region of several seconds to one or two minutes, the ambient temperature in the proximity of the panel can reach values of 145° C. to 160° C. The surface temperature on the panel reaches values of 130° C. to 140° C. in the embodiment shown

Immediately after irradiation or if the irradiation device at the entrance of the forced-air circulation oven is integrated, the hot circulating air keeps the surface temperature of the MDF panel 8 virtually constant immediately afterwards while the core temperature continues to rise slowly (curves 43 and 44). In order that the core temperature may be prevented from rising above the maximum temperature indicated by the line 45, as the MDF panel 8 passes further through the forced-air circulation oven 6, the temperature in the rear zones are gradually lowered such that the surface temperature is kept as high as possible in order that rapid curing and crosslinking of the powder may be achieved while the core temperature is kept below the critical temperature.

Through the inventive method, as represented in the embodiment, very uniform powder coatings may be produced on MDF panels, without damage occurring to the MDF panel. This applies not only to wood-fiber materials, such as MDF panels, which have been depicted here by way of example, but quite generally with regard to heat-sensitive substrates, especially timber-derived materials generally.

In the case of these substrates, it is only necessary to ensure a minimum level of conductivity in order that the electrostatic powder-coating may be performed. MDF panels should preferably have a residual moisture content of more than 5 for this, especially more than 8, preferably up to 15 wt %, which, for example, may be achieved by storage in climate chambers and the like. The resistance here has a value of approx. 10¹¹Ω. Furthermore, it has proved to be advantageous for the MDF panels to have a density of approx. 800 kg/m³+/−20 kg/m³.

For other materials, the conductivity may be obtained, for example, by corresponding additives or by conductive primer coatings.

Instead of the short-wave infrared radiating elements described in the embodiment, other energy-emitting or radiant-heat devices may be used, especially medium-wave infrared radiating elements and the like. The same applies to the oven downstream of the radiation appliance, in which, in addition to the preferentially used forced-air circulation oven, other ovens may also be used that deliver the same results. Also conceivable here are other types of curing or crosslinking, alternatively or additionally, such as curing by means of UV radiation. To this end, the inventive radiation appliances may again be used with advantage.

Furthermore, it is also conceivable to apply the powder not by electrostatic spraying but also by other known powder-application methods.

The inventive arrangement and method are characterized in that the specific geometry of the radiation appliance (21) or the corresponding mode of operation enables a short but sufficient homogeneous radiation action over the surface of the substrate (8) to be coated, without the core temperature of the substrate exceeding a critical value.

Said arrangement comprises a grinding station (1), a flame-treatment station (2), a spray station (3), a powder-application station (4), a radiation appliance (5), and a curing/crosslinking region (6) that can preferably be continuously passed through. The inventive radiation appliance (21) is characterized in that the radiating elements are displaceably arranged in an annular or circular manner, while the powder-application station (4) is provided with diverting elements which are used to smooth the electrical field on the surface of the substrates and thus prevent concentrations of powder on edges and the like.

1-28. (canceled)

29. A radiation appliance for irradiating surfaces comprising:
at least one carrier; and
at least one energy-radiating element arranged on the at least one carrier;
wherein the at least one carrier or the at least one energy-radiating element defines a plane, with the carrier and/or the energy-radiating element being movable in the plane or parallel to the plane.

30. The radiation appliance in accordance with claim 29, wherein:
the at least one carrier and/or the at least one radiating element may be moved linearly back and forth and/or may be swiveled or rotated about an axis of rotation.

31. The radiation appliance in accordance with claim 29, wherein:
the at least one energy-radiating element is arranged in a circular or annular ring;
the at least one carrier or the at least one energy-radiating element being rotatable about an axis of rotation through a center of the ring.

32. The radiation appliance in accordance with claim 29, wherein:
the at least one energy-radiating element is movably arranged on the at least one carrier.

33. The radiation appliance in accordance with claim 29, wherein:
the at least one energy-radiating emitter is arranged such that it projects in at least one dimension above an object to be heated or is moved over a border of the object to be heated due to movement of the at least one energy-radiating element.

34. The radiation appliance in accordance with claim 29, wherein:
the at least one carrier is formed as a circular or polygonal disc or ring that, along a circumference or at sides of the circular or polygonal disc or ring, has mounting panels arranged at an acute angle such that the mounting panels can swivel relative to a line perpendicular to the circular or polygonal disc or ring; and
the at least one energy-radiating element is arranged on the mounting panels.

35. The radiation appliance in accordance with claim 29, wherein:
at least two opposing carriers are provided which, between themselves, form a passageway for an object to be heated.

36. The radiation appliance in accordance with claim 35, wherein:
at least two energy-radiating elements are provided and a distance between the energy-radiating elements may be altered perpendicularly to the passageway.

37. The radiation appliance in accordance with claim 29, wherein:
the at least one energy-radiating element comprises at least one of an infrared (IR) and ultraviolet (UV) radiating element.

38. An arrangement for powder-coating of objects comprising the radiation appliance in accordance with claim 29 and a transport plane formed by the transport direction along which the object to be heated being moved with respect to the radiation appliance and a vertical line.

39. The arrangement in accordance with claim 38, wherein:
the at least one energy-radiating element is arranged on the carrier such that a principal radiant direction of the at least one energy-radiating element impinges on the transport plane at an acute angle.

40. The arrangement in accordance with claim 38, further including:
a powder-application station and a region for curing or crosslinking the powder, with the radiation appliance being arranged between the powder-application station and the curing or crosslinking region and/or in the curing or crosslinking region.

41. The arrangement in accordance with claim 40, wherein:
the radiation appliance is arranged directly at an entrance area to the curing or crosslinking region or is integrated into the curing or crosslinking region.

42. The arrangement in accordance with claim 38, further including:
a transport device for fully automated transport of the objects to be coated.

43. The arrangement in accordance with claim 38, further including:
at least one surface-processing station for surface processing the object, with the at least one surface-processing station comprising at least one of the group comprising a spraying installation for primers, a spraying installation for water-vapor-assisted application of water soluble primers, a grinding device, a plasma treatment installation and a flame treatment device.

44. The arrangement in accordance with claim 40, wherein:
the curing or crosslinking region has several zones in which different curing or crosslinking conditions are realizable at different temperature regions.

45. The arrangement in accordance with claim 44, wherein:
the curing or crosslinking region comprises a forced-air circulation oven that is designed such that a high air velocity of 1 to 5 m/s may be adjusted.

46. The arrangement in accordance with claim 45, wherein:
air circulation in the forced-air circulation oven is designed such that the air may be circulated from top to bottom, from bottom to top, both from bottom to top and from top to bottom with lateral circulation or/and alternatingly from bottom and top.

47. The arrangement in accordance with claim 38, further including:
one or more sensors for detecting temperatures by means of which values a temperature is regulated via a control unit.

48. A powder-application station for applying powders to objects for the purpose of powder coating for an arrangement in accordance with claim 38, comprising:
a housing;
a retaining device for the objects to be coated that can be moved through the housing;
at least one powder-application device; and
at least one diverting element for diverting charge and smoothing an electrical field pattern at the object to be coated, the at least one diverting element being arranged opposite the powder-application means device, with a transport route for the retaining device and thus the object to be coated being arranged between the at least one diverting element and powder-application device.

49. The powder-application station in accordance with claim 48, wherein:
the at least one diverting element comprises at least one of the following: a perforated metal sheet, a lattice structure, or a slotted metal sheet with a multiplicity of parallel slots or with a multiplicity of vertical blinds arranged beside each other.

50. A method for the powder coating of objects using the arrangement in accordance with claim 38, wherein:
the powder is applied electrostatically;
subsequently melted by radiant heating using the radiation appliance; and
then cured or crosslinked.

51. The method in accordance with claim 50, wherein:
prior to powder application, a surface of the object is processed by grinding and/or plasma treatment and/or flame-treatment and/or painting with a primer.

52. The method in accordance with claim 50, wherein:
a surface temperature on irradiation of the powder is greater than 110° C. and the core temperature remains below 90° C.

53. The method in accordance with 50, wherein:
during curing or crosslinking, a surface temperature is kept above 110° C. almost constant for a certain time and is gradually reduced and a core temperature is kept below 90° C.
